(19) United States
(12) Patent Application Publication
(10) Pub. No.: US 2019/0092008 A1
(43) Pub. Date: Mar. 28, 2019

(54) METHOD OF PRINTING ONTO CYLINDRICAL SURFACE

(71) Applicant: Memjet Technology Limited, Dublin 2 (IE)

(72) Inventors: Samuel Mallinson, North Ryde (AU); Brian Brown, North Ryde (AU)

(21) Appl. No.: 16/141,864

(22) Filed: Sep. 25, 2018

Related U.S. Application Data
(60) Provisional application No. 62/563,585, filed on Sep. 26, 2017.

(51) Int. Cl. B41J 2/145

(52) U.S. Cl. CPC B41J 2/145

(57) ABSTRACT

A method of printing onto a surface of a cylinder having radius R_{c} using a stationary inkjet printhead. The method includes the steps of: rotating the cylinder at an angular velocity ω_{c} of at least π radians per second; and ejecting ink droplets from the printhead at an ejection velocity in the range of 6 to 20 meters per second. The printhead has a print zone with a width Wₚ and first and second nozzle rows positioned distances d₁ and d₂ relative to a centerline of the print zone. The print zone and cylinder fulfil the relationship Wₚ/R_{c}≤0.2, and the first and second nozzle row ejects ink droplets at times T₁ and T₂, whereby T₁=d₁/R_{c}ω; and T₂=d₂/R_{c}ω_{c}.

### CROSS-REFERENCE TO RELATED APPLICATIONS

This application claims priority to and the benefit of U.S. Provisional Patent Application No. 62/563,585, entitled METHOD OF PRINTING ONTO CYLINDRICAL SURFACE, filed Sep. 26, 2017, the disclosure of which is incorporated herein by reference in its entirety.

### FIELD OF THE INVENTION

The present invention relates generally to inkjet printing. It has been developed primarily to enable inkjet printing onto cylindrical surfaces with high print quality.

Background

Pagewide printing dramatically increases print speeds compared to traditional scanning printheads. As such, pagewide inkjet printing is transforming commercial printing as traditional analog printing presses increasingly switch to digital inkjet technology. Digital inkjet printing enables customization of product labelling in a way that cannot be achieved economically using traditional analog printing systems.

The present Applicant has developed and commercialized a number of Memjet® print engines suitable for label printing. For example, U.S. Pat. No. 8,783,845 describes a commercial label printer having a single, full-color printhead; U.S. Pat. No. 9,242,493 describes an alternative commercial label printer with an above-the-web maintenance system; and U.S. application Ser. No. 15/583,006 describes a compact modular commercial printing system, the contents of each of which are incorporated herein by reference.

Pagewide technology has already opened up new commercial markets for digital inkjet printing. Pagewide technology also has potential to transform printing onto aluminum cans. Billions of aluminum cans are produced globally each year and it would be desirable to enable inkjet printing onto such substrates to realize similar advantages to those already being achieved in web-based inkjet printing systems. However, printing onto relatively small cylindrical surfaces presents new challenges for pagewide printing technology, particularly in terms of achieving acceptable print quality.

### SUMMARY OF INVENTION

In a first aspect, there is provided a method of printing onto a surface of a cylinder having radius R_{c} using a stationary inkjet printhead, the method comprising the steps of:

rotating the cylinder at an angular velocity ω_{c} of at least π radians per second; and

ejecting ink droplets from the printhead at an ejection velocity in the range of 6 to 20 meters per second, wherein:

the printhead has a print zone having a length L extending along a length of the cylinder and a width Wₚ;

the print zone contains a plurality of nozzle rows extending along the length L arranged in a plane above the surface of the cylinder;

the print zone has a centreline aligned with an axis of rotation of the cylinder;

a first nozzle row is positioned at a distance d₁ relative to the centreline and a second nozzle row is positioned at a distance d₂ relative to the centreline;

d₂>d₁;

a strip of the surface is aligned with the centreline at a nominal time zero T₀;

the first nozzle row ejects ink droplets at a time T₁ and the second nozzle row ejects ink droplets at a time T₂;

R_{c} is in the range of 10 to 100 mm;

Wₚ/R_{c}≤0.2;

T₁=d₁/R_{c}ω_{c}; and

T₂=d₂/R_{c}ω_{c}.

In a second aspect, there is provided a method of printing onto a surface of a cylinder having radius R_{c} using a stationary inkjet printhead, the method comprising the steps of:

rotating the cylinder at an angular velocity ω_{c} of at least π radians per second; and

ejecting ink droplets from the printhead at an ejection velocity in the range of 6 to 20 meters per second,

wherein:

the printhead has a print zone having a length L extending along a length of the cylinder and a width Wₚ;

the print zone contains a plurality of nozzle rows extending along the length L arranged in a plane above the surface of the cylinder;

the print zone has a centreline aligned with an axis of rotation of the cylinder;

a first nozzle row is positioned at a distance d₁ relative to the centreline and a second nozzle row is positioned at a distance d₂ relative to the centreline;

d₂>d₁;

a strip of the surface is aligned with the centreline at a nominal time zero T₀;

the first nozzle row ejects ink droplets at a time T₁ and the second nozzle row ejects ink droplets at a time T₂;

R_{c} is in the range of 10 to 100 mm;

Wₚ/R_{c}>0.2; and

T₂>d₂/R_{c}ω_{c}.

Advantageously, the present invention provides acceptable print quality when printing onto cylinders having relatively small diameters.

Preferably, dot placement of ink droplets ejected from the second nozzle row is within 5 microns of dots printed by the first nozzle row.

Preferably, the radius R_{c} is in the range of 20 to 50 mm.

Preferably, the angular velocity ω_{c} is at least 2π radians per second.

In one embodiment d₁ may be zero such that the first nozzle row is aligned with the centreline. In other embodiments d₁ may be non-zero such the first nozzle row is offset from the centreline. In some embodiments d₂=Wₚ/2.

In respect of the first aspect, the print zone width Wₚ is preferably in the range of 0.5 to 6 mm; and Wₚ/R_{c} is preferably ≤0.1, or preferably ≤0.05.

In respect of the second aspect, the print zone width Wₚ is preferably in the range of 6 to 20 mm; and Wₚ/R_{c} may be in the range of 0.21 to 0.5.

The printhead may comprises a monochrome printhead or a full-color printhead.

The printhead may comprise a plurality of printhead chips butted together in a line, as described in, for example, U.S. Pat. No. 7,290,852, the contents of which are incorporated herein by reference. Alternatively, the printhead may comprise a plurality of staggered overlapping printhead chips, as described in, for example, U.S. Pat. No. 8,662,636, the contents of which are herein incorporated by reference.

Preferably, the cylinder is a standard aluminum can.

As used herein, the term “ink” is taken to mean any printing fluid, which may be printed from an inkjet printhead. The ink may or may not contain a colorant. Accordingly, the term “ink” may include conventional dye-based or pigment based inks, infrared inks, metallic inks, fixatives (e.g. pre-coats and finishers) and the like.

### BRIEF DESCRIPTION OF THE DRAWINGS

One or more embodiments of the present invention will now be described with reference to the drawings, in which:

FIG. 1 is a schematic side view of a printhead printing onto a surface of a cylinder;

FIG. 2 is a schematic side view of a printhead having staggered overlapping printhead chips;

FIG. 3 is a schematic side view of a printhead having butting printhead chips in a line.

### DETAILED DESCRIPTION

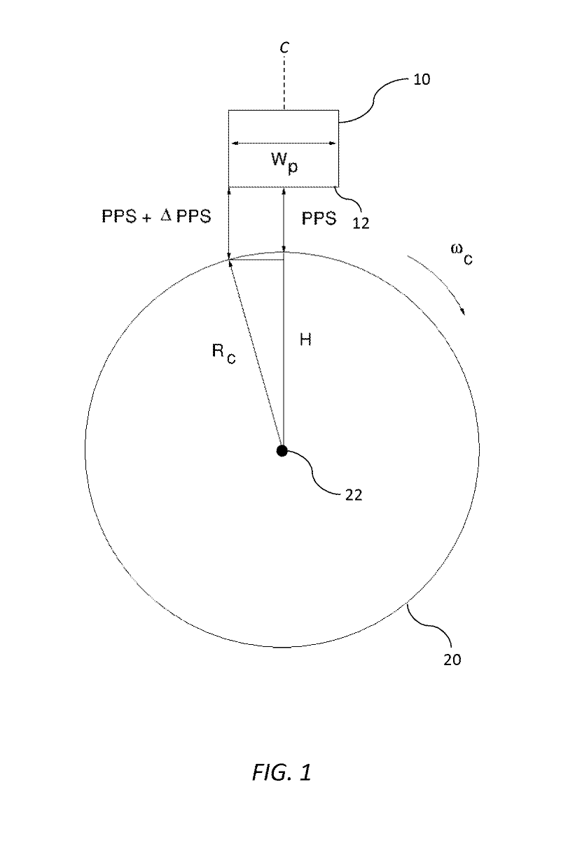

FIG. 1 shows schematically a printhead 10 for printing onto a surface of a cylinder 20, such as a can of beverage. The printhead 10 has print zone of width Wₚ and a centreline C, which is aligned with a central rotation axis 22 of the cylinder 20. The cylinder 20 has a radius R_{c} and a rotation speed of ω_{c} by means of suitable rotation mechanism (not shown). A planar nozzle plate 12 of the printhead 10 and the cylinder surface are separated by a nominal pen-to-paper spacing (PPS) at the centreline C of the print zone, whilst at the edges of the print zone the separation is increased by an amount denoted ΔPPS. A lengthwise strip of the cylinder is aligned with the centreline C at a nominal time zero T₀.

Due to differences in time-of-flight (TOF) of ink droplets ejected from the printhead 10, the droplets ejected from regions towards the edge of the printhead will be misplaced in a nominal y-axis relative to those fired from the centre. Furthermore, the distance between the printed rows is increased due to the curvature of the surface, which increases the path length of the surface from the centreline C relative to a typical planar surface.

Drop Misplacement Due to TOF Differences

A nozzle at one edge of the print zone is positioned at a distance of Wₚ/2 from the centreline C. The value of ΔPPS can be determined for this nozzle as the difference between R_{c} and the distance denoted H in the FIG. 1, and then:

$$\begin{matrix} \begin{matrix}Δ PPS = {R}_{c} - H \\ = {R}_{c} - \sqrt{\text{?} - \frac{{W}_{p}^{2}}{4}} \\ = {R}_{c} ( 1 - \sqrt{1 - \frac{{W}_{p}^{2}}{4 {R}_{c}^{2}}} )\end{matrix} & ( Eqn . 1 ) \\ \text{?} \text{indicates text missing or illegible when filed} & \end{matrix}$$

The TOF is given by the distance from the active printing width to the cylinder surface divided by the droplet velocity U_{d}, so we can find the change in TOF, ΔTOF, as follows:

$$\begin{matrix} \begin{matrix}Δ TOF = \text{?} - \text{?} \\ = \frac{PPS + {R}_{c} ( 1 - \sqrt{1 - \text{?}} )}{{U}_{d}} - \frac{PPS}{{U}_{d}} \\ = \frac{{R}_{c} ( 1 - \sqrt{1 - \text{?}} )}{{U}_{d}}\end{matrix} & ( Eqn . 2 ) \\ \text{?} \text{indicates text missing or illegible when filed} & \end{matrix}$$

The surface velocity of the can is U_{c}=R_{c}ω_{c}, and so the misplacement Δ_{y} due to differences in TOF in the y direction is:

$$\begin{matrix} \begin{matrix}\text{?} = {R}_{c} \text{?} Δ TOF \\ = \frac{\text{?} ( 1 - \sqrt{1 - \text{?}} )}{{U}_{d}}\end{matrix} & ( Eqn . 3 ) \\ \text{?} \text{indicates text missing or illegible when filed} & \end{matrix}$$

Drop Misplacement Due to Increased Path Length of Curved Surface

A nozzle at one edge of the print zone is positioned at a distance of Wₚ/2 from the centreline C. The curved surface of the cylinder means that the path length travelled by the surface from the centreline to a position aligned with this nozzle is greater than Wₚ/2. The arc length y_{θ} between the landing locations of a centreline nozzle and an edge nozzle is given by:

$$\begin{matrix}{y}_{θ} = {R}_{c} θ \\ = {R}_{c} arccos \sqrt{1 - \frac{{W}_{p}^{2}}{4 {R}_{c}^{2}}}\end{matrix} \qquad ( Eqn . 4 )$$

Therefore, the extra path length Aye of the surface relative to a typical planar surface is given by:

$$Δ {y}_{θ} = {R}_{c} arccos \sqrt{1 - \frac{{W}_{p}^{2}}{4 {R}_{c}^{2}}} - \frac{{W}_{p}}{2} \qquad ( Eqn . 5 )$$

### EXAMPLES

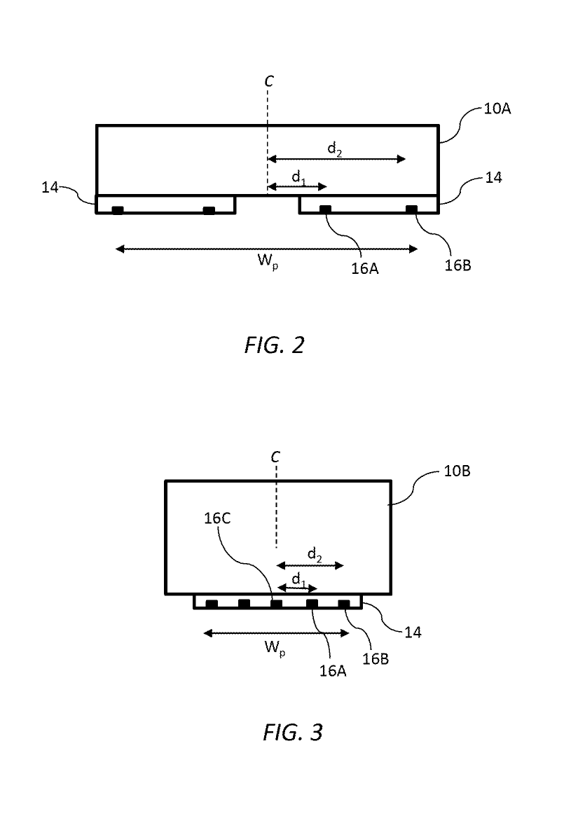

FIGS. 2 and 3 show two different types of pagewide printheads suitable for printing onto cylinders with a droplet ejection velocity of about 10 m/s. In FIG. 2, the printhead 10A is of a type having staggered overlapping printheads chips 14 and a relatively wide print zone Wₚ of 9 mm. Each printhead chip 14 has two nozzle rows: a first nozzle row 16A is at a distance d₁ from the centreline C and a second nozzle row 16B is at a distance d₂ from the centreline C.

In FIG. 3, the printhead 10B is of a type having butting printheads chips and a relatively narrow print zone Wₚ of 0.7 mm. Each printhead chip 14 has five nozzle rows: a central nozzle row 16C aligned with the centreline C, a pair of first nozzle row 16A at a distance d₁ either side of the centreline C, and a pair of second nozzle rows 16B is at a distance d₂ either side of the centreline C.

Using Eqns. 3 and 5, Table 1 shows the total droplet misplacement (Δy+Δy_{θ}) due to TOF differences and increased path length of the second nozzle row 16B furthest from the centreline C for the two printheads 10A and 10B. In each case, the cylinder 20 is a standard beverage can have a radius R_{c} of 33.02 mm, the rotation speed is 2π radians per second, and the rightmost nozzle row 16 is configured to eject ink droplets at a time T₂=d₂/R_{c}ω_{c}.

TABLE 1
Comparison of droplet misplacements

| | | | | Δy | Δy_{θ} | Δy + Δy_{θ} |
|---|---|---|---|---|---|---|
| Example | Printhead | Wₚ (mm) | Wₚ/R_{c} | (μm) | (μm) | (μm) |
| 1 | 10A | 9 | 0.28 | 6.5 | 14.5 | 21 |
| 2 | 10B | 0.7 | 0.01 | 0.04 | 0.007 | 0.047 |

In Example 1, where Wₚ/R_{c}=0.28, the droplet misplacement is about 21 microns, which will produce objectionable print quality artefacts. However, in Example 2, where Wₚ/R_{c}=0.01, the droplet misplacement is 0.047 microns, which will not produce any visibly perceptible print quality artefacts.

The poorer print quality exhibited in Example 1 may be corrected by adjusting the timing signal for each nozzle row. For example, the timing signal for the rightmost nozzle row 16B may be somewhat delayed (whereby T₂>d₂/R_{c}ω_{c}) to compensate for the droplet misplacement.

The foregoing describes only some embodiments of the present invention, and modifications of detail may be made thereto without departing from the scope of the invention, the embodiments being illustrative and not restrictive.

1. A method of printing onto a surface of a cylinder having radius R_{c} using a stationary inkjet printhead, the method comprising the steps of:
rotating the cylinder at an angular velocity ω_{c} of at least π radians per second; and
ejecting ink droplets from the printhead at an ejection velocity in the range of 6 to 20 meters per second,
wherein:
the printhead has a print zone having a length L extending along a length of the cylinder and a width Wₚ;
the print zone contains a plurality of nozzle rows extending along the length L arranged in a plane above the surface of the cylinder;
the print zone has a centreline aligned with an axis of rotation of the cylinder;
a first nozzle row is positioned at a distance d₁ relative to the centreline and a second nozzle row is positioned at a distance d₂ relative to the centreline;
d₂>d₁;
a strip of the surface is aligned with the centreline at a nominal time zero T₀;
the first nozzle row ejects ink droplets at a time T₁ and the second nozzle row ejects ink droplets at a time T₂;
R_{c} is in the range of 10 to 100 mm;
Wₚ/R_{c}≤0.2;
T₁=d₁/R_{c}ω_{c}; and
T₂=d₂/R_{c}ω_{c}.

2. The method of claim 1, wherein dot placement of ink droplets ejected from the second nozzle row is within 5 microns of dots printed by the first nozzle row.

3. The method of claim 1, wherein R_{c} is in the range of 20 to 50 mm.

4. The method of claim 1, wherein ω_{c} is at least 2π radians per second.

5. The method of claim 1, wherein the first nozzle row is either aligned with or offset from the centreline

6. The method of claim 1, wherein Wₚ is in the range of 0.5 to 6 mm.

7. The method of claim 6, wherein Wₚ/R_{c} is less than 0.05.

8. The method of claim 1, wherein the printhead is a monochrome or a full-color printhead.

9. The method of claim 1, wherein the cylinder is a standard aluminum can.

10. The method of claim 1, wherein the droplet ejection velocity is in the range of 8 to 15 meters per second.

11. A method of printing onto a surface of a cylinder having radius R_{c} using a stationary inkjet printhead, the method comprising the steps of:
rotating the cylinder at an angular velocity ω_{c} of at least π radians per second; and
ejecting ink droplets from the printhead at an ejection velocity in the range of 6 to 20 meters per second,
wherein:
the printhead has a print zone having a length L extending along a length of the cylinder and a width Wₚ;
the print zone contains a plurality of nozzle rows extending along the length L arranged in a plane above the surface of the cylinder;
the print zone has a centreline aligned with an axis of rotation of the cylinder;
a first nozzle row is positioned at a distance d₁ relative to the centreline and a second nozzle row is positioned at a distance d₂ relative to the centreline;
d₂>d₁;
a strip of the surface is aligned with the centreline at a nominal time zero T₀;
the first nozzle row ejects ink droplets at a time T₁ and the second nozzle row ejects ink droplets at a time T₂;
R_{c} is in the range of 10 to 100 mm;
Wₚ/R_{c}>0.2; and
T₂>d₂/R_{c}ω_{c}.

12. The method of claim 11, wherein dot placement of ink droplets ejected from the second nozzle row is within 5 microns of dots printed by the first nozzle row.

13. The method of claim 11, wherein R_{c} is in the range of 20 to 50 mm.

14. The method of claim 11, wherein ω_{c} is at least 2π radians per second.

15. The method of claim 11, wherein the first nozzle row is either aligned with or offset from the centerline.

16. The method of claim 11, wherein Wₚ is in the range of 6 to 20 mm.

17. The method of claim 16, wherein Wₚ/R_{c} is in the range of 0.21 to 0.5

18. The method of claim 11, wherein the printhead is a monochrome or a full-color printhead.

19. The method of claim 11, wherein the cylinder is a standard aluminum can.

20. The method of claim 11, wherein the droplet ejection velocity is in the range of 8 to 15 meters per second.
